(19) United States
(12) Patent Application Publication
(10) Pub. No.: US 2015/0281807 A1
(43) Pub. Date: Oct. 1, 2015

(54) Wireless Sensory and Data Transmission System

(71) Applicant: Yang Pan, Singapore (SG)

(72) Inventor: Yang Pan, Singapore (SG)

(21) Appl. No.: 14/228,329

(22) Filed: Mar. 28, 2014

(51) Int. Cl. H04Q 9/00; H04W 84/18

(52) U.S. Cl. CPC H04Q 9/00; H04W 84/18; H04Q 2209/43; H04Q 2209/88

(57) ABSTRACT

A wireless sensory and data transmission system comprises a plurality of data collection devices (nodes), a movable wireless power supply and an information collection apparatus. The movable power supply receives an instruction from the information collection apparatus and moves to a position nearby one of the devices. The device receives power wirelessly from the movable power supply and switches on for collecting environmental data through one or more sensors. The collected data is transmitted to the information collection apparatus directly or indirectly via the movable power supply.

### CROSS-REFERENCE TO RELATED APPLICATIONS

N.A.

### BACKGROUND

1. Field of Invention

This invention relates to an information collecting system, specifically to a wireless sensory and data transmission network.

2. Description of Prior Art

Recently, much work has been directed towards the building of networks of distributed wireless sensor nodes. Sensor nodes in such networks conduct measurements at distributed locations and relay the measurements, via other data collection points. Wireless sensor networks, generally are envisioned as encompassing a large number of sensor nodes, with traffic flowing from the sensor nodes into a much smaller number of measurement data collection points through information collection apparatus. Sensor nodes are commonly equipped, for example, with sensors, a local storage unit, a processor and wireless communication devices. Such sensor nodes are typically small and the communication devices are typically short range communication transceivers that form an ad hoc communication network.

Generally, the sensor nodes have one or more of the following characteristics: a) the nodes are desired to operate for extended periods of time on battery power; b) the nodes have limited computation, memory and communication capability often due to power constraints; c) the nodes typically communicate using a short range ad hoc communication network; d) the nodes are commonly installed in remote or other environments that preclude normal communication and control of the devices; and e) the nodes are often inexpensive. Sensor nodes are generally expected to be long-lived (deployed for years), un-tethered (both in terms of communication and power), and unattended (and so are capable of self configuring and self-adapting).

Sensor nodes may have capability of measuring at least one characteristic in their environment, such as detecting ambient conditions (e.g., temperature, humidity, movement, sound, light, or the presence or absence of certain objects). Many potential applications of wireless sensor networks exist, including as example of physiological monitoring, environmental monitoring, condition-based maintenance, military surveillance, precision agriculture, geophysical monitoring, and/or monitoring various other types of events.

While individual sensor nodes may have limited functionality, the global behavior of the wireless sensor network can be quite complex. The information collection apparatus may be a mobile station connectable to an existing communication network such as the Internet.

Typically, the primary resource constraint of sensor nodes in sensor networks is energy. Because many sensor networks deploy sensor nodes that are battery powered and that can scavenge only a small amount of energy from their surroundings, limited battery power is one of major hurdles in achieving desired longevity of network operation. Reducing power consumption of the wireless sensor networks has been a topic of extensive study. The problem has not been fully resolved.

It is therefore desired that sensors in wireless sensor network do not carry batteries. Power can be supplied from an external source in a wireless manner.

### SUMMARY OF THE INVENTION

It is therefore an object of the present invention to provide a wireless sensor network system comprising passive wireless sensor nodes that achieves longevity of the operation by receiving external power wirelessly without consuming on-board battery power.

In one embodiment, the wireless sensor network comprises one or a plurality of data collection devices, a movable wireless power supply and an information collection apparatus. Upon receiving an instruction from the information collection apparatus, the movable wireless power supply moves towards a selected device in the network. Positions of each of the data collection devices maybe stored in a storage unit of the movable wireless power supply. The movable wireless power supply further includes a positioning unit and a moving mechanism. The movable power supply transmits power wirelessly to the device when it is nearby the device. Upon receiving the power, the device switches on for collecting one of or several of environmental data and transmits the data to the information collection apparatus directly or indirectly via the movable wireless power supply.

In one implementation, the wireless power transmitted from the movable power supply to the data collection device is in an un-coded radio-frequency form. In another implementation, the wireless power is in a form of optical energy.

The data collection devices are passive devices without an on-board battery. The movable power supply can move from one device to another device controlled by the information collection apparatus.

In another embodiment, the information collection apparatus is located in a remote location. The apparatus is connected to the movable wireless power supply through a communication network such as, for example, the Internet.

The information collection apparatus and the movable wireless power supply maybe two standalone devices. The apparatus and the movable wireless power supply may also be the same device.

In yet another embodiment, the wireless power supply is installed in a fixed location. The data collection devices are confined in a space, wherein the devices can receive wireless power from the wireless power supply effectively.

In one implementation, the movable wireless power supply is a robot that can move freely on the ground. In another implementation, the movable wireless power supply is a flying object that can move freely in the air and can land in a location nearby a selected data collection device.

### BRIEF DESCRIPTION OF THE DRAWINGS

For a more complete understanding of the present invention and its various embodiments, and the advantages thereof, reference is now made to the following description taken in conjunction with the accompanying drawings:

FIG. 1 is a schematic diagram of an exemplary wireless sensor network system in one embodiment;

FIG. 2 is a schematic diagram of an exemplary wireless sensor network illustrating the movable wireless power supply is connected wirelessly to a data collection device, wherein both power and communication links are depicted;

FIG. 3 is a schematic diagram of an exemplary wireless sensor network illustrating that collected data is transmitted from the device to the information collection apparatus directly through an ad hoc wireless communication link;

FIG. 4 is a schematic functional block diagram of an exemplary data collection device;

FIG. 5 is a schematic functional block diagram of an exemplary movable wireless power supply;

FIGS. 6-7 are flow diagrams depicting steps of the operation of the wireless sensor network system;

FIG. 8 is a schematic diagram of an exemplary wireless sensor network with the movable power supply and the information collection apparatus as a single device;

FIG. 9 is a schematic diagram of an exemplary wireless sensor network in another embodiment with the information collection apparatus connecting to the movable wireless power supply through a communication network;

FIG. 10 is a schematic diagram of an exemplary wireless sensor network in yet another embodiment with the wireless power supply is installed in a fixed location.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

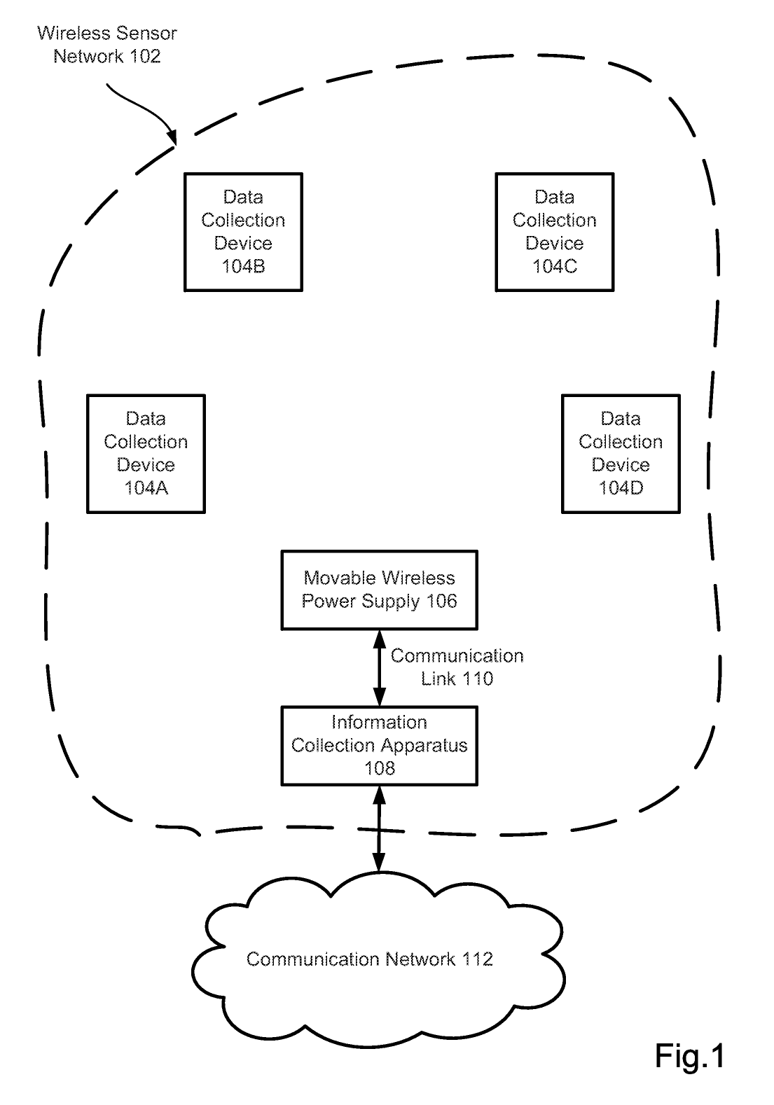

FIG. 1 is a schematic diagram of an exemplary wireless sensor network 102 in one embodiment. The network comprises a plurality of data collection devices 104. 104A-D is illustrated in an exemplary manner only. There may be more data collection devices in a wireless sensor network 102. There may be less data collection devices in the network. In an extreme case, there may be only one data collection device in the network. The data collection device further comprises one or more sensors. The sensors may be used to measure one or multiple environmental parameters that include but are not limited to temperature, pressure, humidity, flow and various chemical contents. The data collection devices are passive devices and are not powered by an on-board battery or by any other on-board power supply. The data collection devices can be deployed in any location in a room or in a field. When there is no on-board battery is required, it is simple and easy to deploy the devices at almost any location.

Wireless sensor network 102 further includes an information collection apparatus 108. In an exemplary case, information collection apparatus is a mobile computing and communication device that includes but is not limited to a smart phone, a tablet computer, a wearable computing and communication device, a remote controller, a laptop computer and a desktop computer. In another exemplary case, information collection apparatus is a dedicated computing and communication device. Information collection apparatus further comprises a communication unit that connects to a movable wireless power supply 106 through a communication link 110. In one implementation, communication link 110 is a short range wireless communication link that conforms to a short range communication standard such as, for example, the Bluetooth (IEEE 802.11b and its amendments), or the ZigBee (IEEE 802.15.4 and its amendments), or the WiFi (IEEE 802.11 and its amendments). Communication link 110 may also be an optical type of connection. Information collection apparatus 108 can be connected to a communication network 112 in a manner known in the art. In an exemplary case, communication network 112 is the Internet.

Movable wireless power supply 106 includes a moving mechanism and can move towards anyone of the data collection devices after receiving an instruction from information collection apparatus 108. When the movable wireless power supply is positioned sufficiently close to one of the data collection devices, power can be transferred effectively from the information collection apparatus to the device wirelessly. In an exemplary case, when the movable wireless power supply is within 20 cm of the data collection device, radio-frequency (RF) power generated from a power generator in the movable wireless power supply can be transmitted to the data collection device. A power receiving unit in the data collection device receives the power and switches on the device. The sensor or sensors powered by received power collect one or more environmental parameters. The collected data will be transmitted by a transceiver directly or indirectly to the information collection apparatus. Ad hoc communication links are used for the data transmission.

In one implementation, movable wireless supply 106 moves on the ground through its moving mechanism in a manner similar to a robot. In another implementation, movable wireless supply 106 moves in the air as a flying object and lands in a location that is close to a selected data collection device. After an ad hoc communication link is established between movable wireless power supply 106 and one of the data collection devices, received wireless signal may be used to further optimizing of the position of the movable wireless power supply 106 to the device to enable an effective wireless power transmission. The movable power supply may determine optimized moving trajectory by detecting changes of received wireless signal.

Information collection apparatus 108 includes a controller and a file storage unit. In one implementation, the movement of wireless power supply 106 is controlled by the controller of the apparatus through executing of a software program stored in the file storage unit. Information collection apparatus 108 may also receive a user's instruction through a user interface of the apparatus and transmit an instruction to movable wireless power supply 106 accordingly. In another implementation, at least a part of program is stored in movable wireless power supply 106. Identities and locations of the data collection devices may be stored in the information collection apparatus or be stored in the movable wireless power supply. There may be many ways of sharing control functionalities between the information collection apparatus and the movable wireless power supply. All these variations fall into the scope of the present invention as obvious to one with the ordinary skill in the art.

The environmental data may be collected on a routine base controlled by the information collection apparatus. The environmental data may also be collected on an ad hoc base controlled by the information collection apparatus. Furthermore, activation of one data collection device may be based upon measurement results of another data collection device.

Because no on-board battery is required, a data collection device can be deployed to any location easily. Power is only provided when there is a need to measure. The need is triggered by the information collection apparatus.

Wireless sensor network 102 may be deployed to a home. Movable wireless power supply 106 may be designed and constructed as a robot when moving on the ground or as a flying artificial bird or plane when moving in the air.

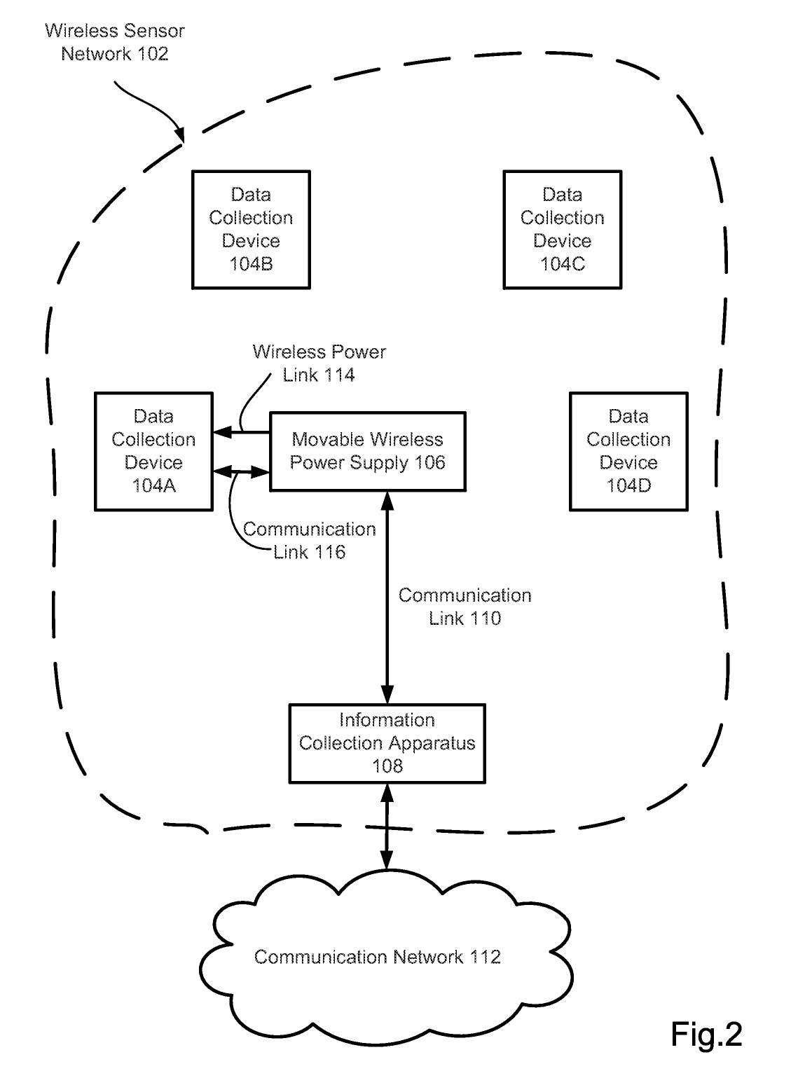

FIG. 2 is a schematic diagram of an exemplary wireless sensor network 102 illustrating movable wireless power supply 106 is connected wirelessly to data collection device 104A. Movable wireless power supply 106 transmits power to data collection unit 104A through wireless power link 114. In one implementation, RF power is generated in movable wireless power supply 106 and is transmitted to data collection device 104A. A RF power receiving unit in data collection device 104A receives the RF power and converts the received RF power into a DC power though a power converter. The DC power is used to switch on various subsystems in the device that include but are not limited to one or more sensors, a controller and a transceiver. In an exemplary case, the RF power is in a form of un-coded radio frequency electromagnetic wave.

In another implementation, optical power is generated by a generator in movable wireless power supply 106 and is converted to electrical power by a photo-detector in data collection device 104A.

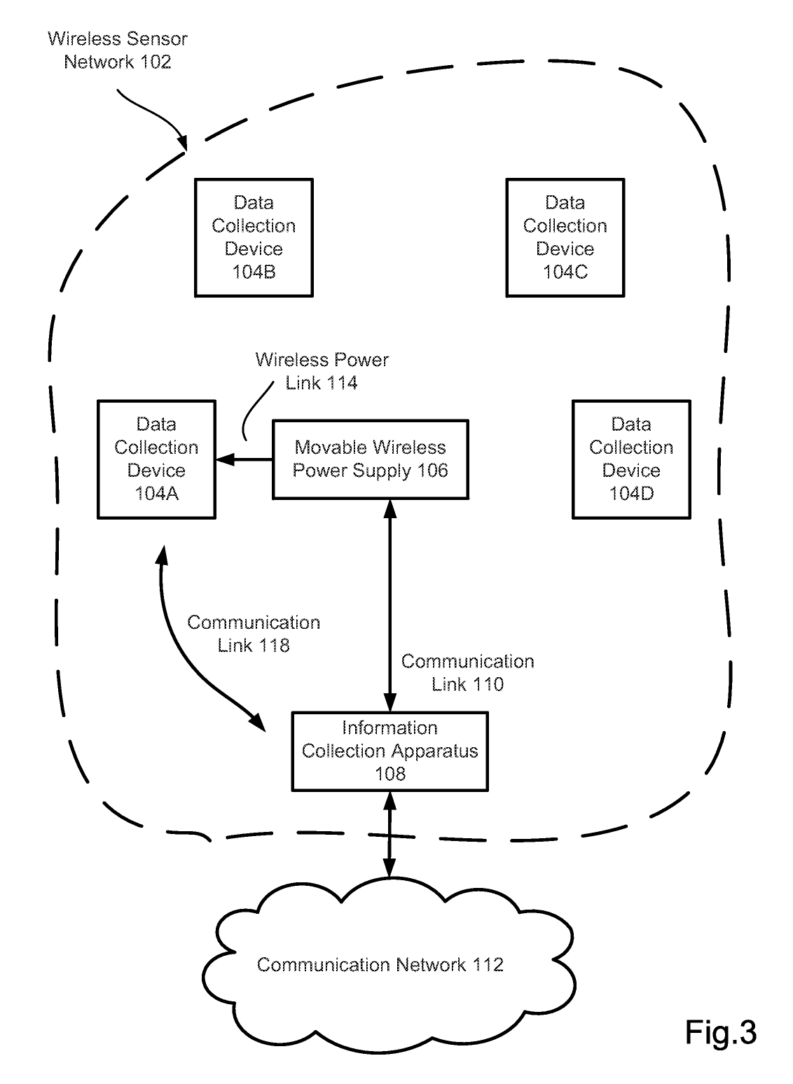

Data can be exchanged between data collection device 104A and movable wireless power supply 106 through wireless communication link 116. In one implementation, wireless communication link may be conformed to an ad hoc short range communication standard such as the Bluetooth (IEEE 802.11b and its amendments), or the ZigBee (IEEE 802.15.4 and its amendments), or the WiFi (IEEE 802.11 and its amendments). In another implementation, wireless communication link 116 may be an optical communication link. In a slightly different implementation, data collected by data collection device 104A may be transmitted to information collection apparatus directly through wireless data link 118 as shown in FIG. 3. Wireless data link 118 may have similar characteristics as wireless data link 116.

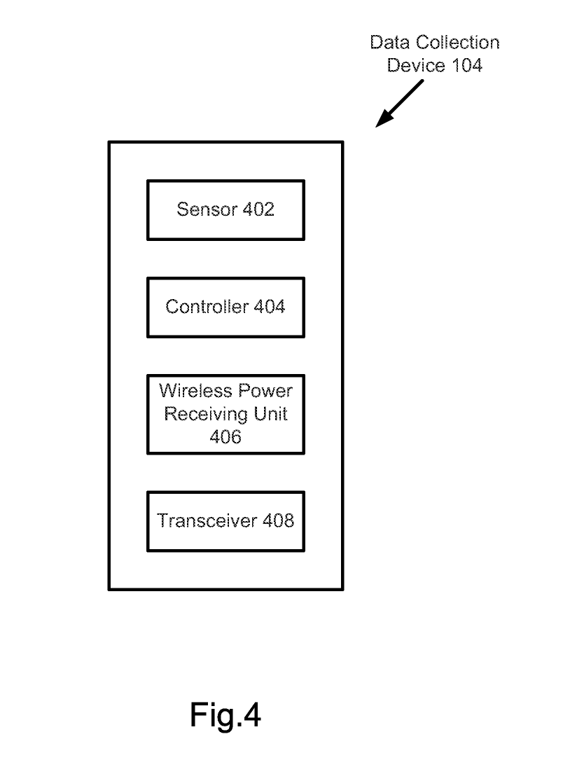

FIG. 4 is a schematic functional block diagram of an exemplary data collection device 104 used in wireless sensor network 102. Data collection device 104 comprises a sensor 402, a controller 404, a wireless power receiver 406 and a transceiver 408. Sensor 402 includes but is not limited to a temperature sensor, a pressure sensor, a humidity sensor, a flow sensor and a sensor for measuring one or more chemical contents. Controller 404 is a microcontroller or a microprocessor pertaining to controlling operation of data collection device 104. Wireless power receiving unit 406 receives wireless power from movable wireless power supply 106, wherein power may be generated and be transmitted in a form of RF power or in a form of optical power. Wireless power receiving unit 406 may be a RF power receiver or an optical power receiver. Received power may be processed to a form of DC power suitable for operations of data collection device 104. Data collected by sensor 402 is transmitted by transceiver 408. Transceiver 408 maybe conformed to an ad hoc short range communication standard as described above.

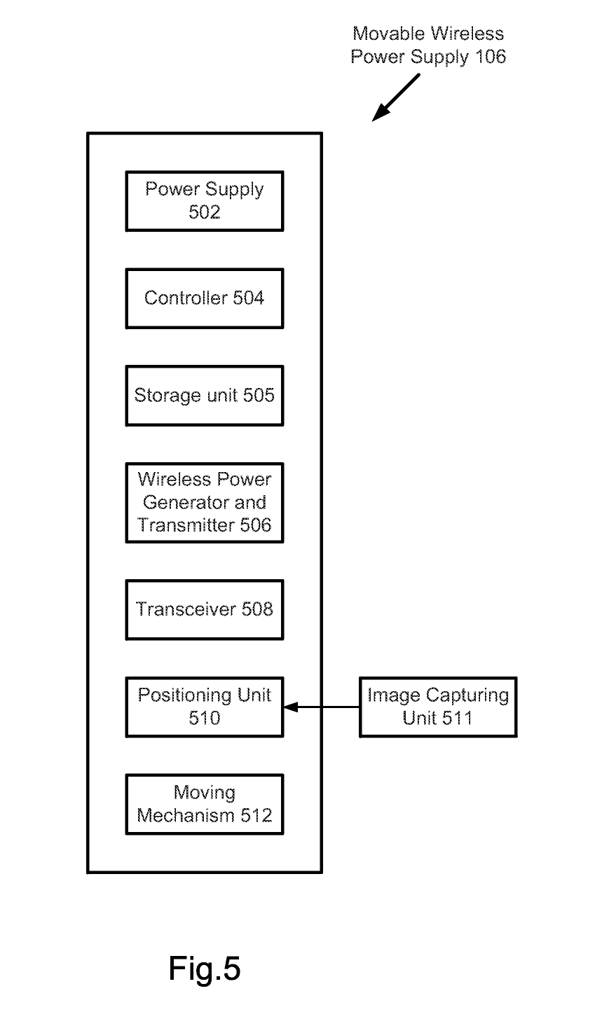

FIG. 5 is a schematic functional block diagram of an exemplary movable wireless power supply 106 used in wireless sensor network 102. Movable wireless power supply 106 comprises a power supply 502. In an exemplary case, power supply 502 is a battery. Operations of movable wireless power supply 106 are controlled by controller 504. Controller 504 may be a microcontroller or a microprocessor. Movable wireless power supply further includes a file storage unit 505 pertaining to storing data. Positions of the data collection devices can be stored in storage unit 505. Positions of the data collection devices may also be stored in the information collection apparatus and be transmitted to the movable wireless power supply. Movable wireless power supply 106 further includes a wireless power generator and transmitter 506 pertaining to generating RF power or optical power. Transceiver 508 is used to communication with data collection devices and with information collection apparatus 108. Movable wireless power supply further includes a positioning unit pertaining to determining position of the power supply to the data collection device. In one implementation, positioning unit 510 includes an image capturing unit 511. It should be noted that including image capturing unit is optional and is not essential for operations of the movable power supply. The image capturing unit 511 takes environmental pictures. Direction of next step movement is determined by either controller 504 in movable device 106 or by a controller in information collection apparatus 108. Moving mechanism 512 moves the power supply either on the ground or in the air. Moving mechanism may include one or more motors.

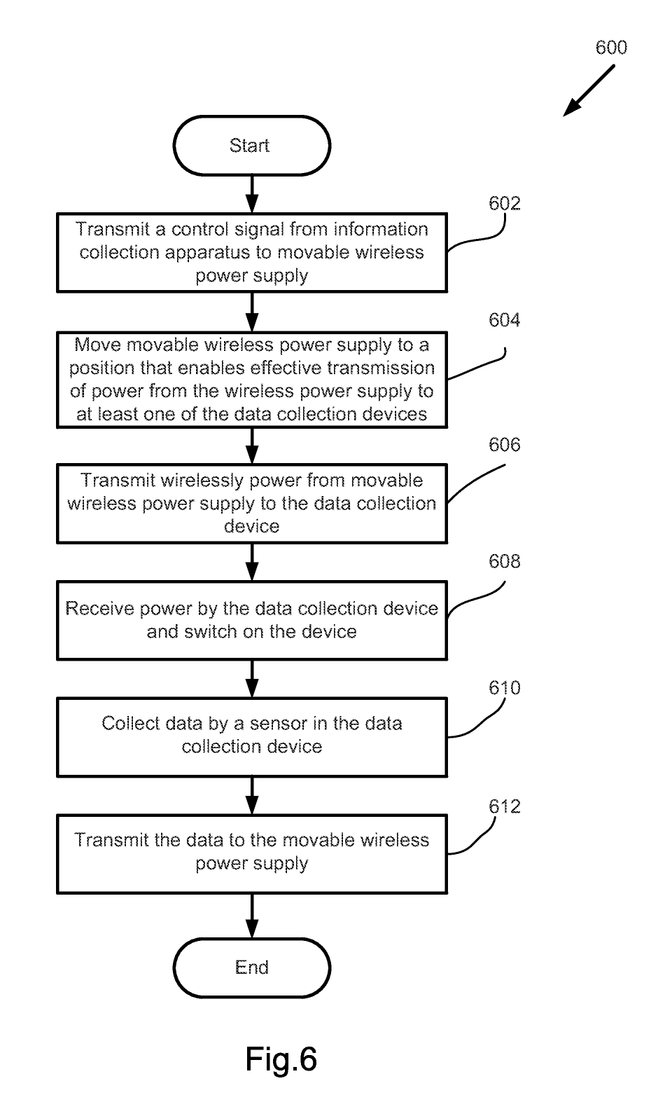

FIG. 6 is a flow diagram depicting steps of the operation of the wireless sensor network 102. Process 600 starts with step 602 that a control signal or an instruction is transmitted from information collection apparatus 108 to movable wireless power supply 106 through communication link 110. In an exemplary case, the signal is transmitted through a Bluetooth type of connection. In step 604, movable wireless power supply 106 moves to a position that enables an effective transmission of power wirelessly from movable wireless power supply 106 to one of the data collection devices. In step 606, power is transmitted from movable wireless power supply 106 to the data collection device in a form of RF power or a form of optical power. Transmitted power is received by a power receiving unit in the data collection device in step 608. Received power is processed to a suitable DC form (not shown in FIG. 6). The DC power is used to switch on the data collection device. In step 610, one or more environmental parameters are measured by one or more sensors in the data collection device. In step 612, collected data is transmitted to the movable wireless power supply through communication link 116. The received data can then be transmitted to the information collection apparatus through communication link 110.

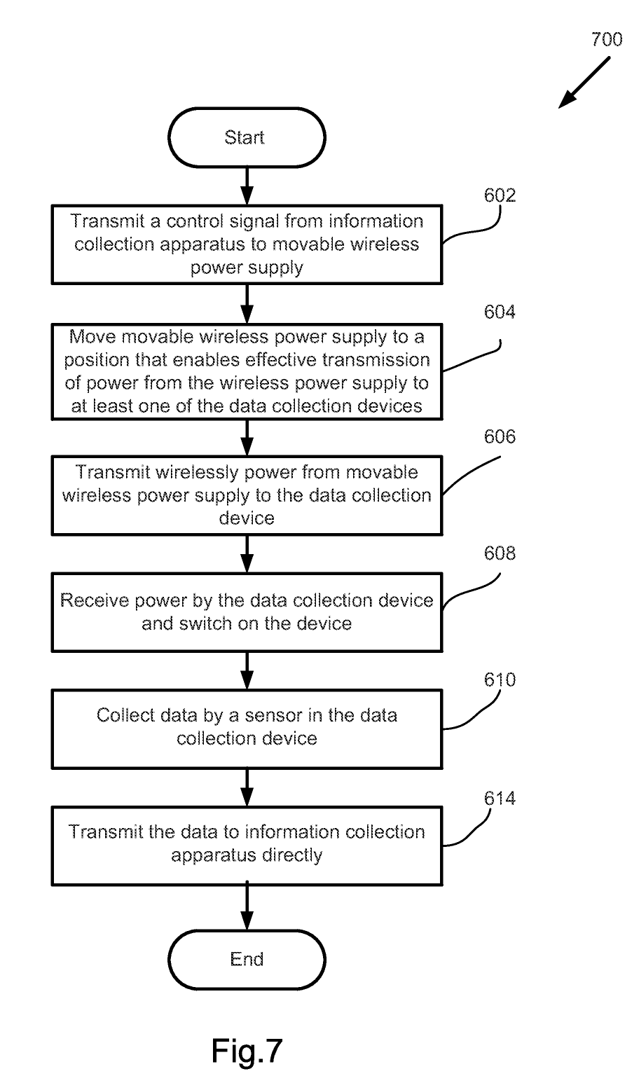

FIG. 7 illustrates a process 700 similar to process 600 except that collected data is transmitted to information collection apparatus 108 directly through communication link 118 in step 614.

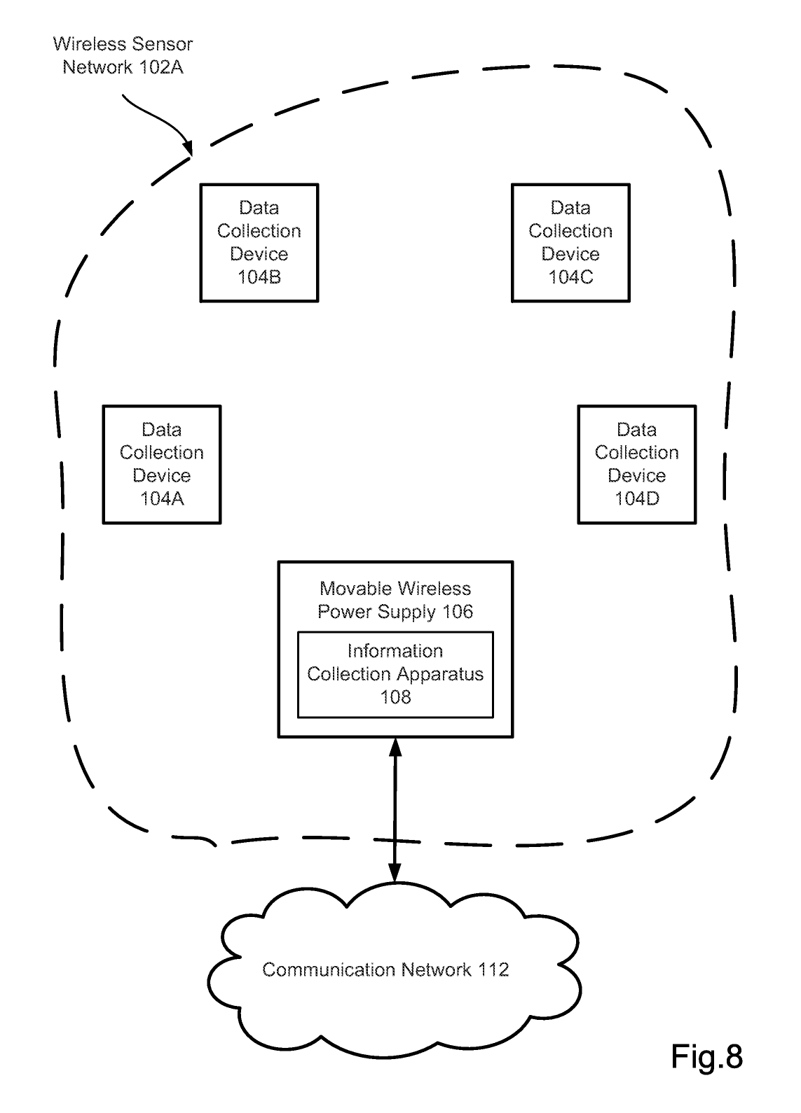

FIG. 8 is a schematic diagram of another exemplary wireless sensor network 102A with the movable power supply 106 and the information collection apparatus 108 combined as a single device that moves together to a data collection device.

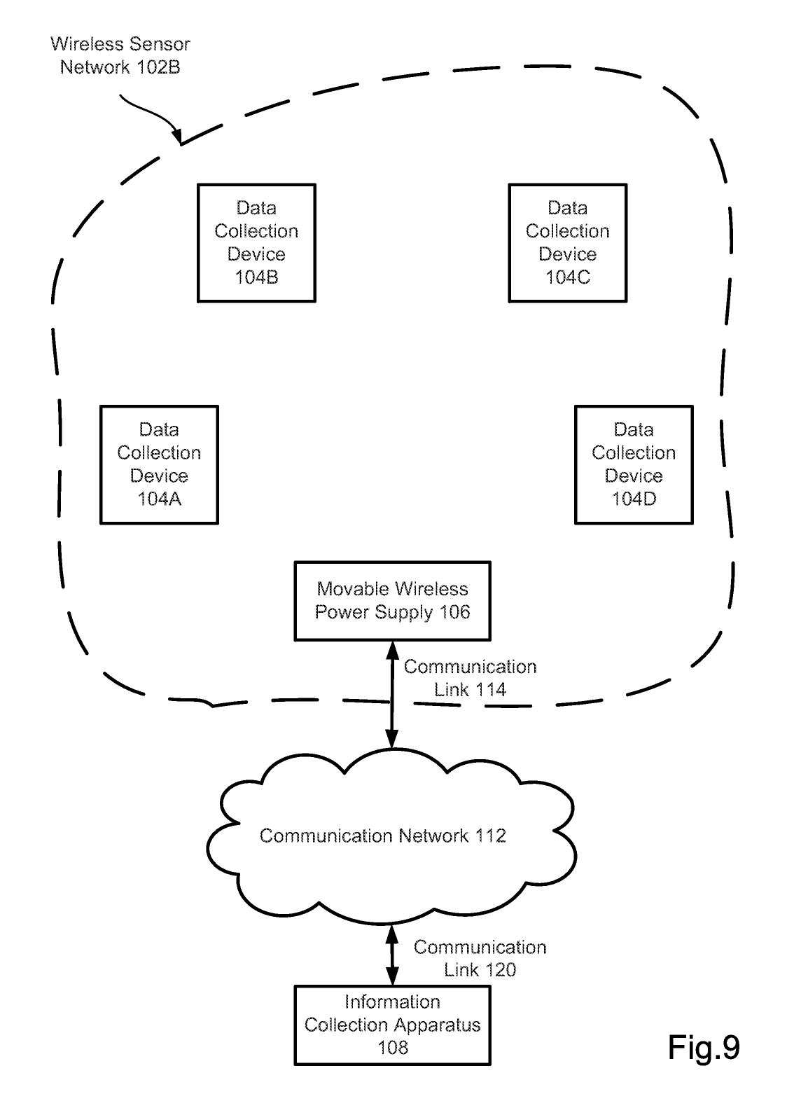

FIG. 9 is a schematic diagram of an exemplary wireless sensor network 102B in another embodiment. In such an implementation, information collection apparatus 108 may be located remotely from movable wireless power supply 106 and the data collection devices. An instruction can be sent from information collection apparatus 108 to movable wireless power supply 106 via communication link 120 and communication network 112. Data collected by the sensor (s) may be transmitted to information collection apparatus 108 through the communication network 112 and the communication link 120. A user may remotely control the data collection process.

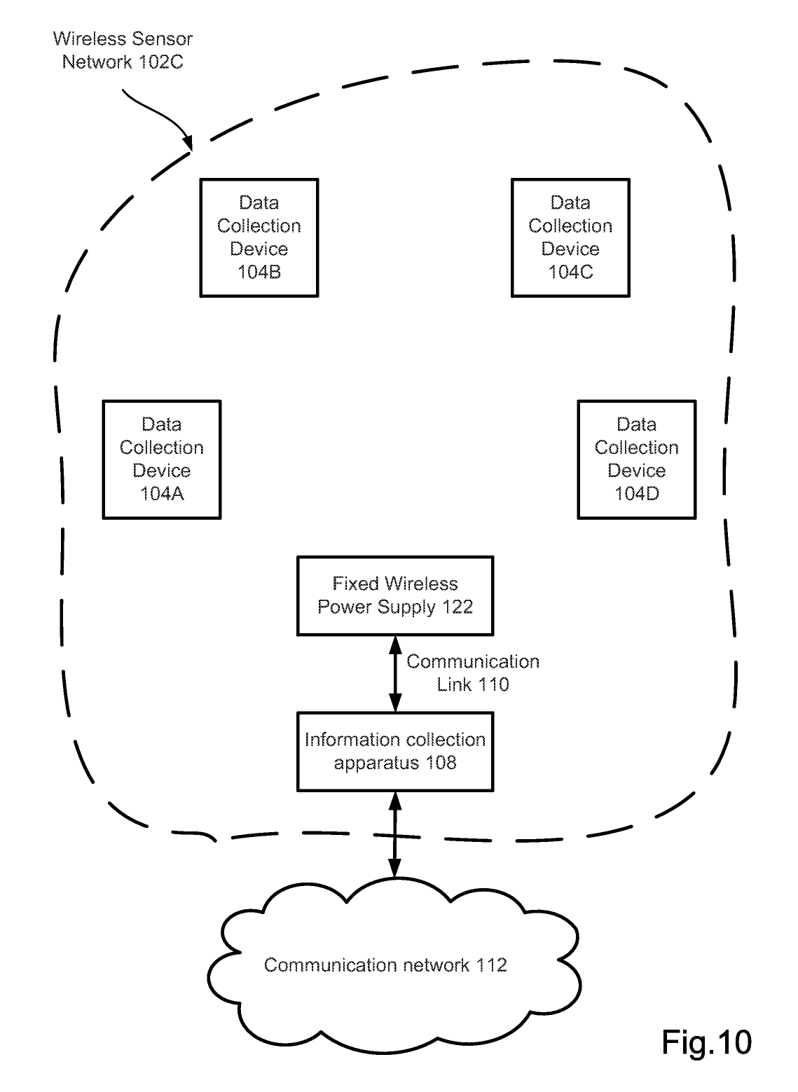

FIG. 10 is a schematic diagram of an exemplary wireless sensor network 102C in yet another embodiment, wherein wireless power supply 122 is installed in a fixed location. Power generated by fixed wireless power supply 122 is strong enough to be received by a plurality of data collection devices located in a confined area. In one implementation, fixed wireless power supply 120 and information collection apparatus 108 are two standalone devices. In another implementation, fixed wireless power supply 120 and information collection apparatus 108 is a single combined device.

1. A wireless sensor network system comprising:
(a) a plurality of data collection devices, each of said devices comprising at least a sensor and a wireless power receiving unit;
(b) a movable wireless power supply comprising a wireless power transmitting unit and a moving mechanism; and
(c) an information collection apparatus,
wherein said information collection apparatus selects a device and said movable wireless power supply moves towards selected device, wherein said selected device is switched on after receiving power wirelessly from said movable wireless power supply, wherein the sensor powered by received power collects at least one environmental parameter and a transceiver of said device powered by received power transmits collected data to said information collection apparatus.

2. The system as recited in claim 1, wherein said movable wireless power supply further comprising a positioning unit pertaining to determining its position relative to said selected device.

3. The system as recited in claim 2, wherein said positioning unit further comprising an image capturing unit.

4. The system as recited in claim 1, wherein said movable wireless power supply further comprising a storage unit, wherein positions of said devices are stored in the storage unit.

5. The system as recited in claim 1, wherein said information collection apparatus and said movable wireless power supply are connected wirelessly through an ad hoc communication link.

6. The system as recited in claim 1, wherein said movable wireless power supply and said selected device are connected through an ad hoc wireless communication link after said selected device is switched on.

7. The system as recited in claim 6, wherein said movable wireless power supply adjusts its position based upon wireless signals received from said selected device.

8. The system as recited in claim 1, wherein said selected device and said information collection apparatus are connected through an ad hoc communication link after said device is switched on.

9. The system as recited in claim 1, wherein said movable wireless power supply transmits power to said device in a form of un-coded radio-frequency electromagnetic wave.

10. The system as recited in claim 1, wherein said movable wireless power supply transmits power to said device in a form of optical energy.

11. A wireless sensor network system comprising:
(a) a plurality of data collection devices, each of said devices comprising at least a sensor and a wireless power receiving unit;
(b) a movable wireless power supply comprising a wireless power transmitting unit and a moving mechanism; and
(c) an information collection apparatus connecting to said movable wireless power supply through the Internet,
wherein said information collection apparatus selects a device and transmits the selection to said movable wireless power supply through the Internet, wherein said movable wireless power supply moves towards selected device accordingly, wherein said selected device is switched on after receiving power wirelessly from said movable wireless power supply, wherein the sensor powered by received power collects at least one environmental parameter and a transceiver of said device powered by received power transmits collected data to said information collection apparatus through the Internet.

12. The system as recited in claim 11, wherein said movable wireless power supply further comprising a positioning unit pertaining to determining its position relative to said selected device.

13. The system as recited in claim 12, wherein said positioning unit further comprising an image capturing unit.

14. The system as recited in claim 11, wherein said movable wireless power supply further comprising a storage unit, wherein positions of said devices are stored in the storage unit.

15. The system as recited in claim 11, wherein said movable wireless power supply and said device are connected through an ad hoc wireless communication link after said selected device is switched on.

16. The system as recited in claim 11, wherein said movable wireless power supply transmits power to said device in a form of un-coded radio-frequency electromagnetic wave.

17. A wireless sensor network system comprising:
(a) a plurality of data collection devices, each of said devices comprising at least a sensor and a wireless power receiving unit; and
(b) an information collection apparatus comprising a wireless power transmitting unit,
wherein said at least one of said devices is switched on for collecting and transmitting data collected from the sensor after receiving power wirelessly from said wireless power transmitting unit.

18. The system as recited in claim 17, wherein said information collection apparatus and said device are connected through an ad hoc wireless communication link after said device is switched on.

19. The system as recited in claim 17, wherein said information collection apparatus transmits power to said device in a form of un-coded radio-frequency electromagnetic wave.

20. The system as recited in claim 17, wherein said information collection apparatus transmits power to said device in a form of optical energy.
